(19) United States
(12) Patent Application Publication
(10) Pub. No.: US 2012/0092959 A1
(43) Pub. Date: Apr. 19, 2012

(54) TECHNIQUE AND SYSTEM TO DETERMINE PROPERTIES OF A SYSTEM OF HYDRAULIC FRACTURES

(75) Inventors: Stewart Thomas TAYLOR, Farmers Branch, TX (US); Joel Herve LE CALVEZ, Farmers Branch, TX (US)

(73) Assignee: SCHLUMBERGER TECHNOLOGY CORPORATION, Houston, TX (US)

(21) Appl. No.: 12/906,189

(22) Filed: Oct. 18, 2010

(51) Int. Cl. G01V 1/00

(52) U.S. Cl. 367/32; 367/57

(57) ABSTRACT

A technique includes determining a magnitude and frequency distribution of seismic events attributable to hydraulic fracturing in a given stage of a well. The technique includes based on the determined magnitude and frequency distribution, predicting at least one additional magnitude and frequency distribution of seismic events attributable to hydraulic fracturing in at least one additional stage of the well. The technique includes determining at least one seismic property of a system of hydraulic fractures based at least in part on the determined additional magnitude and frequency distributions.

### BACKGROUND

The invention generally relates to a technique and system to determine properties of a hydraulically induced fracture system.

Hydraulic fracturing is used to increase the conductivity of a subterranean formation for such purposes as producing hydrocarbons or injecting fluids into an injection well. In a typical hydraulic fracturing operation, a fracturing fluid is communicated downhole into a wellbore and injected under pressure into the surrounding formation to hydraulically induce a system of fractures. In this manner, fluid injected under pressure into the formation causes a pressure buildup until the in-situ stress in the formation is exceeded, which results in an expanding fracture network that extends some distance from the wellbore. Particulate matter called “proppant” typically is added to the fracturing fluid. The proppant is deposited in the fractures as the fracturing progresses for purposes of holding the fractures open when the pressure relaxes. A typical hydraulic fracturing operation may involve pressurizing and fracturing many zones, or stages, in the well; and it may take several hours to perform the hydraulic fracturing in each stage.

The progress of the hydraulic fracturing operation may be monitored in real or near real time by detecting the seismic energy that is emitted due to the fracturing process. In this manner, the hydraulic fracturing typically generates a significant amount of seismic events, which may be detected using seismic sensors. The resulting data may be processed for purposes of quantifying the extent of the hydraulically induced fracture system.

### SUMMARY

In an embodiment of the invention, a technique includes determining a magnitude and frequency distribution of seismic events attributable to hydraulic fracturing in a given stage of a well. The technique includes predicting at least one additional magnitude and frequency distribution of seismic events attributable to hydraulic fracturing in at least one additional stage of the well based on the determined magnitude and frequency distribution. The technique includes determining at least one seismic property of a system of hydraulic fractures based at least in part on the magnitude and frequency distributions.

Advantages and other features of the invention will become apparent from the following drawing, description and claims.

### BRIEF DESCRIPTION OF THE DRAWING

FIG. 1 is a schematic diagram of a well illustrating a fracturing system according to an embodiment of the invention.

FIG. 2 is a flow diagram depicting a technique to determine at least one seismic property of a system of hydraulically induced fractures according to an embodiment of the invention.

FIG. 3 illustrates exemplary graphs of magnitude and frequency distributions of seismic events recorded at different time intervals during hydraulic fracturing of a stage of a well.

FIG. 4 is an illustration of an exemplary graph of a number of seismic events recorded during hydraulic fracturing of the stage.

FIG. 5 is an illustration of an exemplary graph of a seismicity rate of seismic event sequences recorded during hydraulic fracturing of the stage.

FIG. 6 is an illustration of an exemplary graph of a b value for seismic events recorded during hydraulic fracturing of the stage.

FIG. 7 is an illustration of exemplary graphs of actual and smoothed magnitude and frequency distributions of seismic events recorded during hydraulic fracturing of the stage.

FIGS. 8A and 8B depict a flow diagram illustrating a shear modulus technique to determine total stress drop and total fracture area according to an embodiment of the invention.

FIG. 9 is a schematic diagram of a data processing system according to an embodiment of the invention.

### DETAILED DESCRIPTION

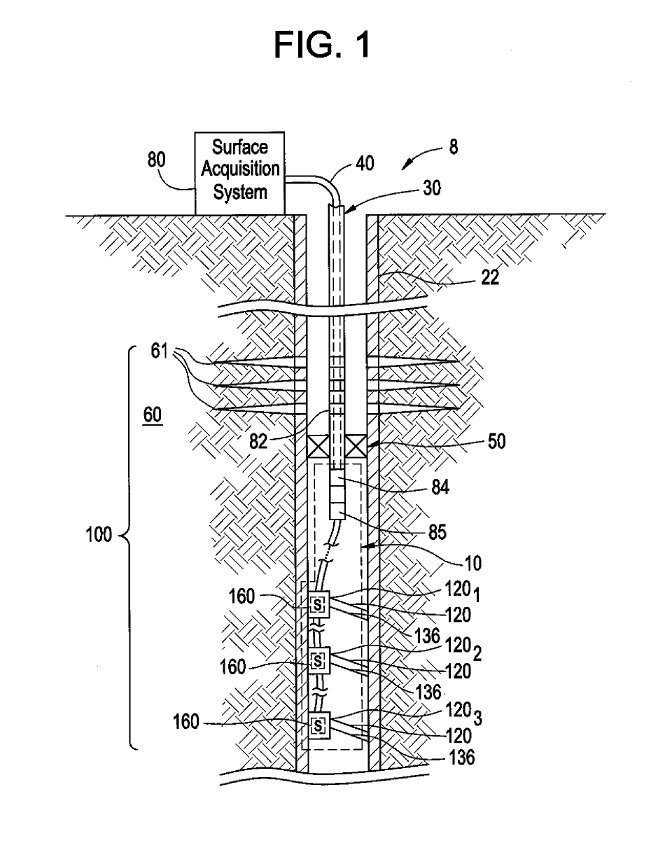

In accordance with embodiments of the invention, a well 8 may have a system similar to the one depicted in FIG. 1 for purposes of conducting and monitoring a hydraulic fracturing operation. For this non-limiting example, the well 8 includes an array of receivers, or sensors, such as seismic energy sensors 160 that acquire measurements that are indicative of seismic events, which are generated due to an ongoing hydraulic fracturing process. In the context of this application, the language “seismic event” is used to refer to both microseismic and non-microseismic seismic events. For the example depicted in FIG. 1, the sensors 160 are disposed in the vicinity of a particular stage 60 of the well, which may be subject to hydraulic fracturing. It is noted that the stage 60 is depicted in FIG. 1 for purposes of an example, as other stages of the well 8 not depicted in FIG. 1 may be hydraulically fractured, in accordance with embodiments of the invention; and the sensors 160 may be used to monitor seismic events originating from these other stages as well. For this non-limiting example, the stage 60 contains perforating tunnels 61 that have been formed by a previous downhole perforating operation.

As a non-limiting example, the sensors 160 may be may be part of sensor sondes (sensor sondes 120₁, 120₂ and 120₃, being depicted as examples in FIG. 1) of a borehole monitoring assembly 10 of a downhole borehole assembly 100. As a non-limiting example, the sondes 120 may be pressed against a wall of a casing 22 by activated arms 136 of the sondes 120. In addition to the sondes 120, the borehole monitoring assembly 10 may include such components as a downhole controller 85 in communication with the sensors 160 as well as a transceiver 84 that is in communication with a surface acquisition system 80 via a communication cable 40 for purposes of communicating the acquired seismic data uphole in real or near real time.

In addition to the borehole monitoring assembly 10, the borehole assembly 100 may include, for example, an isolation device, such as a packer 50 (a compression-set packer, mechanically-set packer, a hydraulically-set packer, a weight-set packer, etc., as just a few non-limiting examples) for purposes of isolating the sensor sondes 120 (and thus, the sensors 160) from the fracturing operation. It is noted that this isolation may be used so that flow noise that is caused by the hydraulic fracturing does not affect the measurements by the sensors 160, and furthermore, this isolation protects the sensors 160 from the impact of the fracture treatment. However, it is noted that in accordance with other embodiments of the invention, the sondes 120 and associated sensors 160 may be located in the same region as the stage 160.

In general, the borehole assembly 100 may be run into the well 8 using one out of many different conveyance mechanisms, such as the exemplary tubular string 30 that is depicted in FIG. 1. As a more specific example, the string 30 may be coiled tubing, in accordance with some implementations.

Although FIG. 1 depicts a single well bore, the well may be a multi-lateral well having many other bores that contain stages that are hydraulically fractured; a horizontal well; a deviated portion of a horizontal well; etc, in accordance with the many potential embodiments of the invention.

The seismic data acquired by the sensors 160 may be processed for purposes of determining the total number of seismic events that occur during the hydraulic fracturing operation, and as further described below, this number may be used for purposes of determining various parameters of the system of hydraulically induced fractures. Depending on the particular implementation, this processing may be performed at the well site, such as by the surface acquisition system 80, or the processing may be performed remotely.

The sensors 160 record a complete set of recorded events for the hydraulic fracturing in the stages that are disposed at or near optimal distances from the sensor array, such as the stage 60. In this context, “optimal distances” are distances that are sufficient to permit the sensor array to record all of the seismic events that are attributable to the hydraulic fracturing. However, due to the inherent limitations in the recording geometry, not all of the seismic events may be recorded for hydraulic fracturing occurring in many other stages of the well 8.

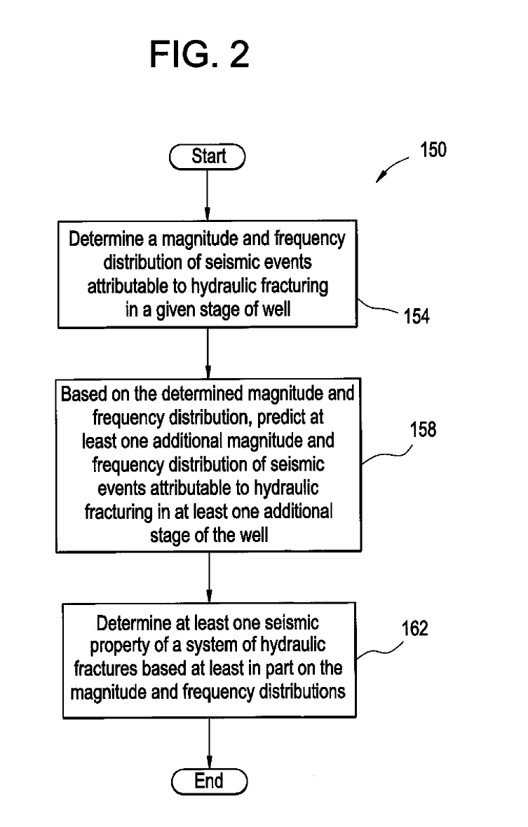

In accordance with embodiments of the invention, systems and techniques are disclosed herein to estimate the number of “missing” seismic events, which are not adequately detected by the seismic sensors 160 and originate in stages that are not optimally spaced from the sensor array. More specifically, referring to FIG. 2, in accordance with embodiments of the invention, a technique 150 includes determining (block 154) a magnitude and frequency distribution of seismic events, which are attributable to hydraulic fracturing in a given stage of a well. This stage is an optimal stage, in that all or nearly all of the seismic events are detected by the seismic sensors 160 and recorded. Based on this determined magnitude and frequency distribution, the technique includes predicting (block 158) at least one additional magnitude and frequency distribution of seismic events attributable to hydraulic fracturing in at least one additional stage of the well. For this example, the predicted distribution(s) are for each stage for which the sensor system does not record all seismic events originating from the stage due to the non-optimal spacing between the sensor array and the stage. The technique 150 includes determining (block 162) at least one seismic property of a system of hydraulically-induced fractures based at least in part on these magnitude and frequency distributions.

In accordance with embodiments of the invention, the magnitude and frequency distribution of seismic events is assumed to follow the Gutenberg-Richter law for earthquake-induced seismic activity. The Gutenberg-Richter law is set forth below:

log N(M)=a−b(M−M_{c}), Eq. 1

where “M” represents seismic magnitude; “N” represents the number of seismic events above the seismic magnitude M; “a” represents a determined parameter (called the “a-parameter” herein) that is the seismicity rate; “b” represents another determined parameter (called the “b-parameter” herein); and “M_{c}” represents the magnitude of completeness, which is defined as the lowest magnitude at which one hundred percent of the seismic events in a space-time volume are detected by determining the a and b-parameters. By determining the a and b-parameters from measurements acquired from stages in which all seismic events are recorded, the magnitude and frequency distribution of seismic events for other stages in which the seismic measurements are incomplete may be estimated.

It has been discovered that the a-parameter varies with time and as such, may not be merely be estimated as a constant. More specifically, for the case of hydraulic fracturing, the a-parameter is time varying because the seismic event rate varies due to time variations in downhole pressure and proppant concentration. Thus, for a given volume of Earth subjected to hydraulic fracturing, the a-parameter is an important and non-trivial variable that may not be estimated by merely averaging the results of a large number of hydraulic fracturing measurements at many distinct geographical sites. Therefore, the a-parameter is determined for a specific volume of earth over a specific period of time, in accordance with embodiments of the invention.

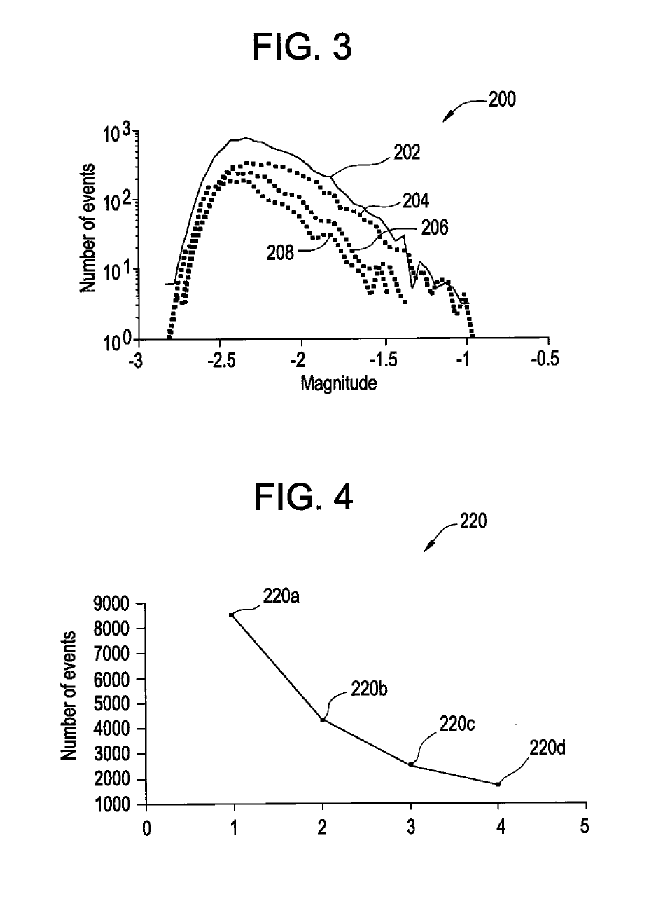

FIG. 3 is an illustration 200 depicting exemplary graphs 202, 204, 206 and 208 of the frequency and magnitude distribution of seismic events that originated in a stage that was optimally located with respect to the sensor array. More specifically, the graph 202 depicts the total number of seismic events recorded during the entire fracturing time interval and is the summation of the events that occur during the three intervals of time represented by the graphs 204, 206 and 208. The graph 204 represents the number of recorded seismic events for the first third of the fracturing time interval; the graph 206 represents the number of recorded seismic events for the second third of fracturing time interval; and the graph 208 represents the number of recorded seismic events for the last third of the fracturing time interval. As can be seen, a shift to smaller magnitude events occurs as time progresses.

FIG. 4 depicts an illustration 220 of the number of recorded seismic events, which originated from the stage during the fracturing time interval. The numbers of recorded seismic events during three intervals of equal time are plotted relative to the total number of seismic events recorded during the fracturing time interval. In particular, point 220a represents the number of events for the entire duration of the fracturing time interval; point 220b represents the number of seismic events for the first one third of the fracturing time interval; point 220c represents the number of seismic events for the second one third of the fracturing time interval; and point 220d represents the number of seismic events of the last third of the fracturing time interval. The decline in the number of events toward the end of the fracturing time interval is visually apparent.

In accordance with some embodiments of the invention, the a-parameter is determined assuming that the b-parameter has a value of one, because it has been shown that complete recordings of seismic activity exhibit the tendency for the b-parameter to approach one. With this assumption, the a-parameter is determined as follows:

a=M+log N. Eq. 2

After the a-parameter is determined, the values for the b-parameter for the different seismic event sequences are determined. Although the b-parameter generally has a value of one for natural seismic event sequences recorded over a relatively long period of time, as noted above, the b-parameter may vary significantly for different time segments that form the entire fracturing time interval for the stage. However, just as in natural seismic event sequences, the value of the b-parameter for a cumulative sum of seismic events originating from different stages of reservoir stimulation also approach a value of one. In accordance with some embodiments of the invention, the b-parameter may be determined using a maximum likelihood method, such as the one that is set forth below:

b=(log₁₀e)/(M_{avg}−Mₘᵢₙ), Eq. 3

where “M_{avg}” represents the average seismic magnitude and “Mₘᵢₙ” represents the minimum seismic magnitude. The Mₘᵢₙ minimum magnitude is also called the catalog completeness, or the magnitude of completeness (M_{c}), which is defined as the lowest magnitude at which one hundred percent of the events in a space-time volume are detected. Below this magnitude, there is some fraction of the seismic events produced that are not recorded by the array of seismic sensors, because the events are too small to be detected or because the events are masked by the coda of a larger seismic event.

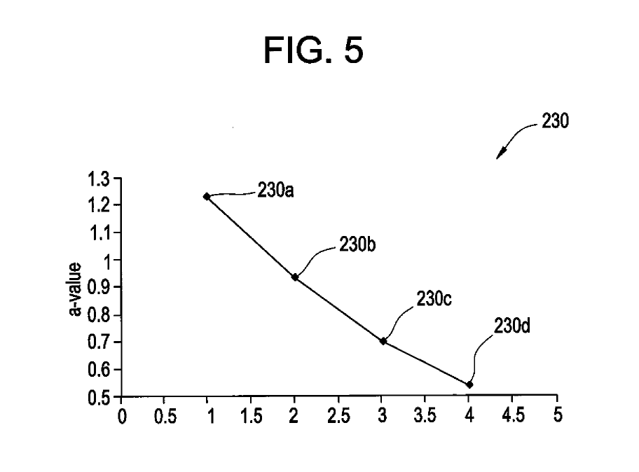

FIG. 5 is an exemplary plot 230 of the a-parameter based on recorded seismic events from a given stage over a fracturing time interval. In particular, point 230a is the value of the a-parameter for the duration of the entire fracturing time interval; point 230b is the value of the a-parameter for the first one third of the fracturing time interval; point 230c is the value of the a-parameter for the second one third of the fracturing time interval; and point 230d is the value of the a-parameter for the last one third of the fracturing time interval. As can be seen from FIG. 5, the a-parameter, or seismicity rate, declines toward the end of the fracturing in the stage; and the decline in the a-parameters quantifies the change in the seismicity rate according to the frequency and magnitude distribution.

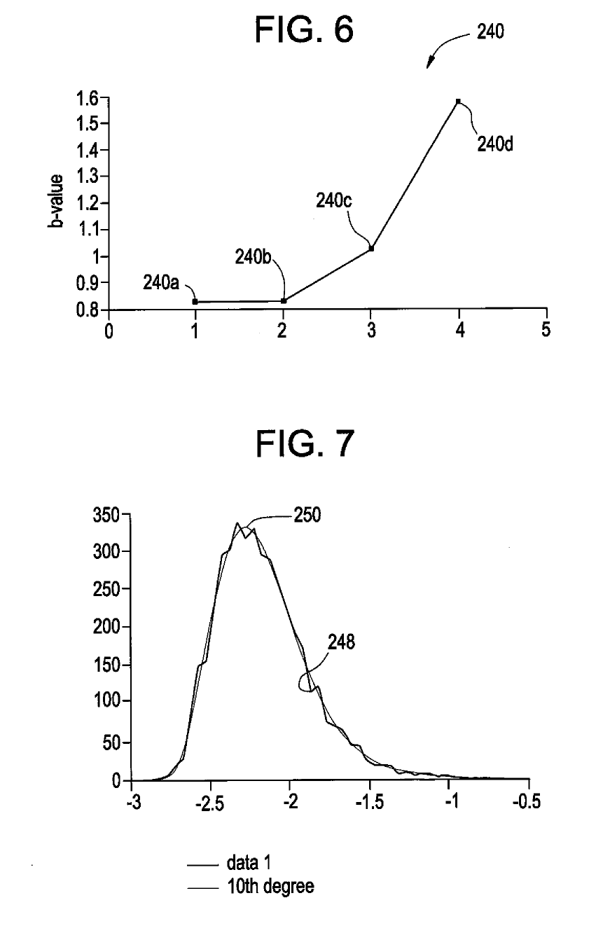

FIG. 6 depicts an exemplary plot 240 of the b-parameter determined from recorded seismic events from the stage. In particular, point 240a is the value for the b-parameter for the duration of the entire fracturing time interval; point 240b is the value for the b-parameter for the first one third of the fracturing time interval; point 240c is the value for the b-parameter for the second one third of the fracturing time interval; and point 240d is the value for the b-parameter for the last one third of the fracturing time interval. The increase in the b value, as can be seen from FIG. 6, quantifies the temporal variability of the b value over the fracturing time interval.

After the a-parameter and b-parameter are determined for a stage in which the stage and sensor array are spaced apart by an optimal distance (i.e., for a stage in which all seismic events are recorded), the corresponding frequency and magnitude distribution may then be determined and smoothed by applying a smoothed curve function. As an example, FIG. 7 depicts an exemplary plot 250 of a magnitude and frequency distribution derived from the calculated a-parameter and b-parameter and a corresponding smoothed curve function 248. The curve function 248 may be uniformly sampled to derive a smoothed estimate of the number of events that should be recorded for the case of optimal sensor array placement. Thus, the smoothed estimate is used to tabulate the estimated number of events for each magnitude bin over a specific time interval, which is a segment of the overall fracturing time interval for the stage. For the exemplary case depicted in FIG. 7, the interval is the second one-third of the fracturing time interval

It is noted that the smoothing of the magnitude distributions may or may not be used, depending on the particular implementation. However, smoothing of the magnitude distributions within the equal intervals of time may be performed for purposes of filtering out environmental noise and instrumental noise, when present. Noise in the seismic data may result in poor picking of events used to establish event time of arrival and other seismic parameters. Smoothing of the magnitude distribution is also generally associated with finer sampling of the smoothed curve, as compared to the sampling rate at which the raw data is sampled. The finer sampling of the magnitude interval helps better estimate the total number of events after summing in cases where there is a site specific variation from the typical b value. A site specific variation creates a greater number of events at a certain magnitude, as compared to those that would otherwise be recorded at sites where the value of the b-parameter is equal to one.

After the estimate of the total number of events is established for the optimal case, the magnitude and frequency distributions for other stages, which present the non-optimal cases may be predicted. The estimated total numbers of events for any particular stage may then be used calculate such parameters as total stress drop and total fracture area created by the reservoir stimulation.

As a non-limiting example, the total stress drop and the total fracture area for a given stage may be determined using one of two models. The first model is the Madariaga, Brune, and Keilis-Borok (MBK) model, which uses the following parameters: source radius, source magnitude and source stress drop. The MBK model is described in, for example, Madariaga, P: “Dynamics of an expanding circular fault,” Bulletin of the Seismological Society of America, (1976) 66, p. 639-666; and is also disclosed in Brune, J. N: “Tectonic Stress; and the Spectra of Shear Waves from Earthquakes,” Journal of Geophysical Research, (1970) 75, p. 4997-5009. These parameters, in conjunction with the optimal estimation of the total of seismic activity (as described here) may be used directly to calculate the total stress drop and total fracture area.

Another way to calculate the total stress drop and the total fracture area is called the “shear modulus method” herein. The shear modulus uses pressure dependent and depth dependent parameters, which rely on site-specific velocity and density models. The shear modulus method also relies on the source radius.

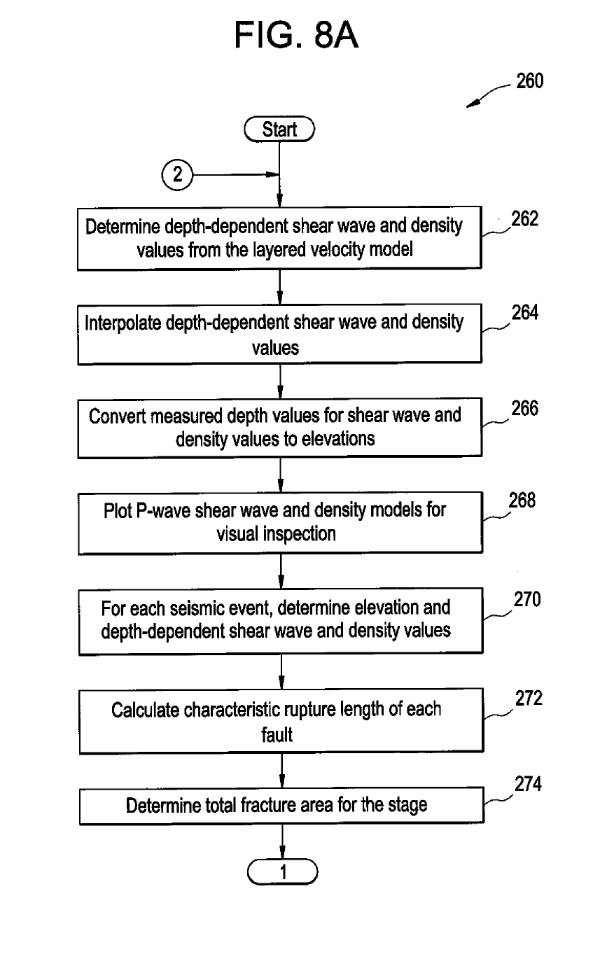

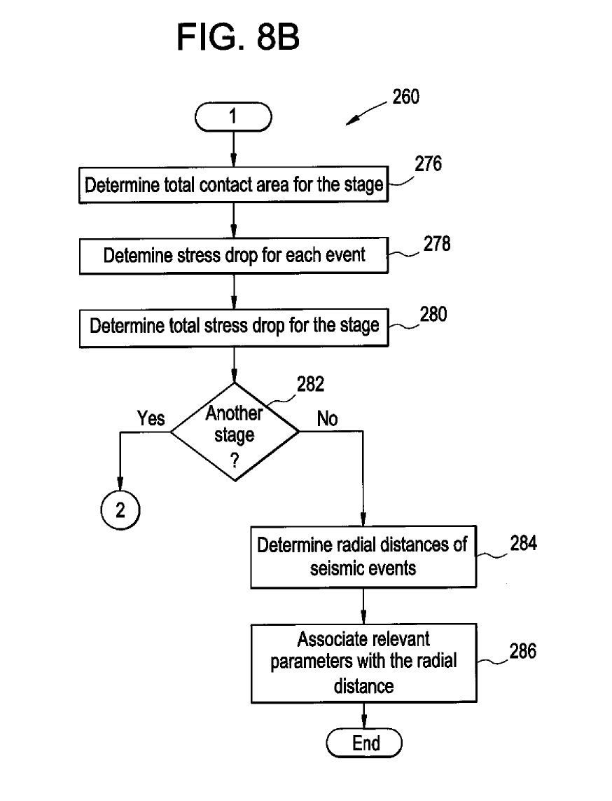

Techniques to estimate the shear modulus and its usage for interpretation of other pertinent elastic parameters are disclosed in Taylor, Stewart, “Vs, Vp, and Trends of Elastic Constants for Active Faults”, Schlumberger (RP P2.4) Poster Station GGG1 (2009) (hereinafter called “Taylor (2009)”). Although Taylor (2009) discloses methods to calculate the shear modulus, the technique used to calculate the shear modulus factor is not disclosed. In general, FIGS. 8A and 8B depict a shear modulus technique 260, in accordance with the shear modulus method, in accordance with some embodiments of the invention. Referring to FIG. 8A, the technique 260 includes determining (block 262) depth-dependent shear wave and density values from a layered velocity model of the site and interpolating (block 264) depth-dependent shear wave and density values to every foot (as an example) using the measured depth. The technique 260 includes converting (block 266) the measured depth values for shear wave and density values to elevations and plotting (block 268) the p-wave, shear wave, and density models for visual inspection. The technique further includes, for each seismic event, determining (block 270) the elevation of the event and determining the depth-dependent shear wave and density values to be used for the determination of the shear modulus factor. The characteristic rupture length of each fault corresponding to the event is then determined, pursuant to block 272. In accordance with some embodiments of the invention, the characteristic rupture length may be determined according to the following equation:

[symbol]

=L/1+P_{ô}(L_{d}/W_{d}), Eq. 4.

where “ [symbol] ” represents the characteristic length; “L” represents the average length of the fault rupture; “P_{ô}” represents the estimated overpressure in the matrix pores; “L_{d}” represents the rupture length as a function of radial distance from the perforation; and “W_{d}” represents the rupture width as a function of radial distance from the perforation.

Next, according to the technique 260, the total of the fracture (face) area for the stage is determined (pursuant to block 274), using estimates of the length and width of the fracture face calculated using the source parameter radius.

Referring to FIG. 8B, the technique 260 further includes determining (block 276) the total contact area for the stage using the fracture area and determining (block 278) the stress drop for each event using the following equation:

Δτ=CG(ū/ [symbol] ), Eq. 5

where “Δτ” represents the change in stress; “C” represents a constant that depends on the geometry of the fault rupture; “G” represents the shear modulus factor; “ū” represents the mean displacement; and “Λ” represents the characteristic length.

Next, according to the technique 260, a summation is made of the stress drops for all of the recorded and estimated seismic events to determine the total stress drop for the stage, pursuant to block 280. If a determination is made (diamond 282) that other stages are to be processed, then control returns to block 262 (see FIG. 8A). Otherwise, the processing for the stages is complete, and the technique 260 includes determining (block 284) the radial distances of the seismic events from the perforation point and associating (block 286) the relevant parameters such as stress drop with the radial distance.

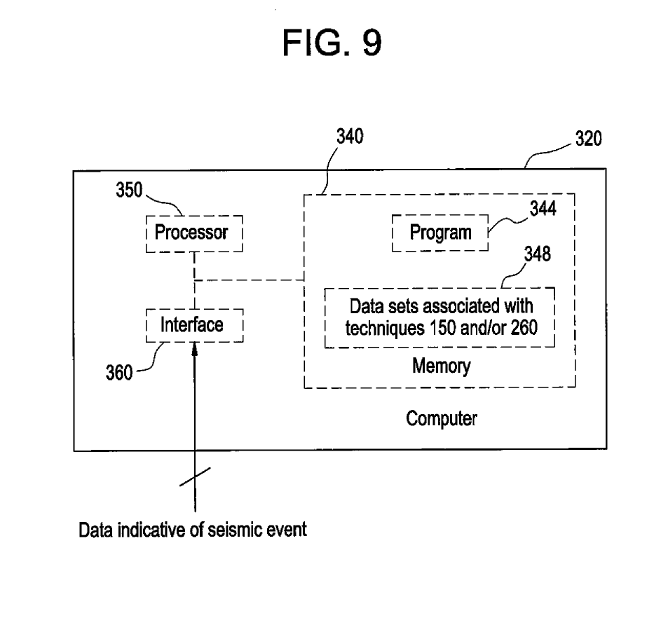

Referring to FIG. 9, in accordance with embodiments of the invention described herein, a data processing system 320 may be used for purposes of performing one or more parts of the techniques 150 and/or 260. The data processing system 320 may be part of the surface acquisition system 80 (see FIG. 1) or may be remote from the well site, depending on the particular embodiment of the invention.

In accordance with some embodiments of the invention, the processing system 320 may include a processor 350, such as one or more processing cores, central processing units (CPUs), microcontrollers, etc. In general, the processor 350 processes data indicative of measurements acquired by a sensor array during hydraulic fracturing. This data may be communicated to the processing system 320 via an interface 360. As non-limiting examples, the interface 360 may be a network interface, removable media, magnetic storage, optical storage, etc.

As depicted in FIG. 9, the processing system 320 may further include a memory 340, which contains program instructions 344 that, when executed by the processor 350 cause the processor 350 to perform one or more parts of the techniques 150 and/or 260. The processing by the processor 350 may produce various initial, intermediate and final data sets 348 associated with the techniques 150 and/or 260. As examples, the data sets may be data sets associated with determined a and b values; determined magnitude and frequency distributions; predicted frequency and magnitude distributions; determined optimal frequency and magnitude distributions; frequency and magnitude distributions estimated for a non-optimal stage; raw seismic data indicative of the hydraulic fracturing measurements; data indicative of calculated seismic properties, such as a total stress drop or a total fracture area; etc. Other variations are contemplated and are within the scope of the appended claims.

While the present invention has been described with respect to a limited number of embodiments, those skilled in the art, having the benefit of this disclosure, will appreciate numerous modifications and variations there from. It is intended that the appended claims cover all such modifications and variations as fall within the true spirit and scope of this present invention.

What is claimed is:

1. A method comprising:
determining a magnitude and frequency distribution of seismic events attributable to hydraulic fracturing in a given stage of a well;
based on the determined magnitude and frequency distribution, predicting at least one additional magnitude and frequency distribution of seismic events attributable to hydraulic fracturing in at least one additional stage of the well; and
determining at least one seismic property of a system of hydraulic fractures based at least in part on the determined and said at least one additional magnitude and frequency distributions.

2. The method of claim 1, further comprising:
measuring seismic activity attributable to hydraulic fracturing in the given stage using a sensor array; and
basing the determination of the magnitude and frequency distribution of seismic events attributable to hydraulic fracturing in the given stage of the well at least in part on measurements acquired due to the measuring.

3. The method of claim 2, wherein each of said at least one additional stage is disposed farther away from the sensor array than a spatial separation between the sensor array and the given stage.

4. The method of claim 1, wherein
determining the magnitude and frequency distribution of seismic events attributable to hydraulic fracturing in the given stage of the well comprises using a sensor array to record substantially all seismic activity in the given stage due to the hydraulic fracturing in the given stage, and
the sensor array cannot record substantially record all seismic activity in each of said at least one additional stage due to a spatial separation between the sensor array and each of said at least one additional stage.

5. The method of claim 1, wherein the act of determining the magnitude and frequency distribution of seismic events attributable to hydraulic fracturing in the given stage of the well comprises determining a seismicity rate of the seismic events attributable to hydraulic fracturing.

6. The method of claim 5, wherein the seismicity rate varies with time.

7. The method of claim 1, wherein the act of determining the magnitude and frequency distribution of seismic events attributable to hydraulic fracturing in the given stage of the well comprises determining magnitude and frequency distributions for different time segments and combining the determined magnitude and frequency distributions for the different time segments.

8. The method of claim 1, wherein the act of determining said at least one seismic property comprises determining a total stress drop.

9. The method of claim 1, wherein the act of determining said at least one seismic property comprises determining a total fracture area.

10. A system comprising:
an interface to receive data indicative of measurements acquired during hydraulic fracturing of a plurality of stages in a well; and
a processor to process the data to:
determine a magnitude and frequency distribution of seismic events attributable to hydraulic fracturing in a given stage of the plurality of stages;
based on the determined magnitude and frequency distribution, predict at least one additional magnitude and frequency distribution of seismic events attributable to hydraulic fracturing in at least one additional stage of the plurality of stages; and
determine at least one seismic property of a system of hydraulic fractures based at least in part on the determined and said at least one additional magnitude and frequency distributions.

11. The system of claim 10, further comprising a sensor array to acquire the data indicative of the measurements, and each stage of said at least one additional stage is disposed farther away from the sensor array than a spatial separation between the sensor array and the given stage.

12. The system of claim 11, wherein the processor is adapted to:
use the sensor array to record substantially all seismic activity in the given stage due to the hydraulic fracturing in the given stage, wherein
the sensor array cannot record substantially record all seismic activity in each of said at least one additional stage due to a spatial separation between the sensor array and each of said at least one additional stage.

13. The system of claim 10, wherein the processor is adapted to determine a seismicity rate to determine the frequency and magnitude distributions of the seismic events attributable to hydraulic fracturing.

14. The system of claim 10, wherein the processor is adapted to determine a total stress drop based at least in part on the determined and said at least one additional magnitude and frequency distributions.

15. The system of claim 10, wherein said at least one seismic property comprises a total fracture area.

16. An article comprising a computer readable storage medium to store instructions that when executed by a computer cause the computer to:
determine a magnitude and frequency distribution of seismic events attributable to hydraulic fracturing in a given stage of a well;
based on the determined magnitude and frequency distribution, predict at least one additional magnitude and frequency distribution of seismic events attributable to hydraulic fracturing in at least one additional stage of the well; and
determine at least one seismic property of a system of hydraulic fractures based at least in part on the determined and said at least one additional magnitude and frequency distributions.

17. The article of claim 16, the storage medium storing instructions that when executed by the computer further cause the computer to:
measure seismic activity attributable to hydraulic fracturing in the given stage using sensor array; and
further base the determination of the magnitude and frequency distribution of seismic events attributable to hydraulic fracturing in the given stage of the well at least in part on measurements acquired due to the measurement of the seismic activity.

18. The article of claim 16, wherein each of said at least one additional stage is disposed farther away from a sensor array than a spatial separation between the sensor array and the given stage.

19. The article of claim 16, the storage medium storing instructions that when executed by the computer further cause the computer to:
determine the magnitude and frequency distribution for different time segments and combine the determined magnitude and frequency distributions for the different time segments.

20. The article of claim 16, wherein said at least one seismic property comprises a total stress drop.

21. The article of claim 16, wherein said at least one seismic property comprises a total fracture area.
